(19) United States
(12) Patent Application Publication
(10) Pub. No.: US 2009/0313465 A1
(43) Pub. Date: Dec. 17, 2009

(54) METHODS AND APPARATUS FOR SECURING OPTICAL BURST SWITCHING (OBS) NETWORKS

(76) Inventors: Pramode K. Verma, Tulsa, OK (US); Yuhua Chen, Houston, TX (US)

Correspondence Address: DUNLAP CODDING, P.C., PO BOX 16370, OKLAHOMA CITY, OK, 73113, US

(21) Appl. No.: 12/471,972

(22) Filed: May 26, 2009

Related U.S. Application Data
(60) Provisional application No. 61/055,696, filed on May 23, 2008.

(51) Int. Cl. H04L 9/32; H04L 29/06; H04L 9/08

(52) U.S. Cl. 713/153; 380/283; 713/161; 380/256

(57) ABSTRACT

An optical network, having an optical communication link and first and second routers. The first router receives and classifies data, then forms a data burst based on destination. The first router sends an encrypted header and the data burst via the optical link. The second router, at least one hop from the first router, receives, decrypts and authenticates the header. Then, the second router extracts data burst information from the header and determines whether the address of the second router is the destination address for the data burst. If so, the second router receives the data burst and sends data to an appropriate line interface. If not, the second router selects and reserves a wavelength on a second optical link for the data burst. The second router selects an encryption key for the header, encrypts and sends the header, and then routes the data burst to the selected wavelength.

### CROSS-REFERENCE TO RELATED APPLICATIONS

The present patent application claims priority to the provisional patent application identified by U.S. Ser. No. 61/055,696, filed May 23, 2008, the entire contents of which is hereby incorporated herein by reference.

### FIELD OF THE INVENTION

The present invention relates to optical networks, and, more particularly, to systems that provide secure communications in optical networks.

### BACKGROUND OF THE INVENTION

Over the last decade, the amount of information that is conveyed electronically has increased dramatically. As the need for greater communications bandwidth increases, the importance of efficient use of communications infrastructure increases as well. The emergence of dense-wavelength division multiplexing (DWDM) technology has improved the bandwidth problem by increasing the capacity of an optical fiber. In wavelength division multiplexing, channels are arranged by a predetermined wavelength interval, and signals are loaded on each channel. Also, a number of channels are optically multiplexed, and the signals are transmitted through an optical fiber. A receiver optically demultiplexes the channels according to their wavelengths and utilizes each channel separately. DWDM is now well established as a principal technology to enable large transport capacities in long-haul communications.

However, the increased capacity creates a serious mismatch with current electronic switching technologies that are designed to process individual channels within a DWDM link. In electronic switching, the optical fiber additionally requires a photoelectric converter for converting an optical signal into an electrical signal and an electro-optic converter for converting an electrical signal into an optical signal, which results in an increased cost. While electronic switching routers such as IP routers can be used to switch data using the individual channels within a fiber, this approach implies that tens or hundreds of switch interfaces must be used to terminate a single DWDM fiber with a large number of channels. This could lead to a significant loss of statistical multiplexing efficiency when the parallel channels are used simply as a collection of independent links, rather than as a shared resource.

In order to solve such problems, there were proposed in the related art optical switching technologies, which do not convert the transferred optical signal into the electrical signal but process the optical signal directly. Optical switching technologies based on wavelength routing (circuit-switching) of a limited pool of wavelengths don't make efficient use of the transmission medium when data traffic dominates the public network. This is the case today where the increasing demand for bandwidth is largely due to a spectacular growth in IP data traffic. All-optical packet switching would be an optimum transfer mode to handle the flood of optical IP packets to and from the Internet core in the most efficient way. However, a number of packet-switching operations (e.g. ultra fast pulsing, bit and packet synchronization, ultra-high-speed switching, buffering and header processing) cannot be performed optically, on a packet-by-packet basis today.

A related art optical burst switching (OBS) network makes use of both optical and electronic technologies. The electronics provides control of system resources by assigning individual user data bursts to channels of a DWDM fiber, while optical technology is used to switch the user data channels entirely in the optical domain. In the OBS, the length of a data packet is variable and packet routing can be performed without an optical buffer by setting a path in advance using a control packet.

In the OBS network, generally, Internet protocol (IP) packets or data stream of any form inputted in an optical domain are gathered as a data burst in an edge node, and such data bursts are routed by way of a core node depending on their destinations or Quality of Services (QoS) and then sent to the destination nodes. Further, a burst header packet and the data burst are respectively transmitted on different channels and at an offset time. That is, the burst header packet is transmitted earlier than the data burst by the offset time and it reserves an optical path through which the data burst is transferred, so that the data burst can be transmitted through the optical network at a high speed without being buffered.

However, optical burst switching networks are vulnerable to security threats. In OBS networks, data can be misdirected and tapped off by undesirable parties.

It is therefore an object of the invention to provide secure measures to optical burst switching networks.

It is another object of the invention to reduce overhead associated with providing security measures to optical burst switching network.

It is another object of the invention to provide a means to realize security measures in OBS edge and core routers.

### SUMMARY OF THE INVENTION

In accordance with the present invention, there is provided methods to provide secure communications in optical burst switching (OBS) networks. The present invention provides methods for secure transmission of data bursts, as well as authentication of burst headers. The present invention provides methods to implement security measures in OBS edge and core routers.

### BRIEF DESCRIPTION OF THE DRAWINGS

A complete understanding of the present invention may be obtained by reference to the accompanying drawings, when considered in conjunction with the subsequent, detailed description, in which:

FIG. 1 illustrates an optical burst switching network;

FIGS. 2(a) and 2(b) shows an example of transmitting a data burst through an optical burst switching network;

FIG. 3 shows the timing relationships between the burst header packet and the data burst;

FIG. 4 shows an optical core router;

FIG. 5 shows an OBS edge router architecture;

FIG. 6 shows an OBS core router architecture;

FIG. 7 shows an example of an orphan burst;

FIG. 8 shows an example of malicious burst header and redirected burst;

FIG. 9 shows the secure OBS framework;

FIG. 10 shows the secure OBS edge router architecture;

FIG. 11 shows the secure OBS core router architecture;

FIG. 12 (a) shows one embodiment of operations in the ingress edge router;

FIG. 12 (b) shows another embodiment of operations in the ingress edge router;

FIG. 13 (a) shows one embodiment of operations in the egress edge router;

FIG. 13 (b) shows another embodiment of operations in the egress edge router;

FIG. 14 shows operations in the core router;

FIG. 15(a) shows key distribution between the ingress edge router and the first hop core router;

FIG. 15(b) shows key distribution between the last hop core router and the egress edge router;

FIG. 15(c) shows key distribution between two adjacent core routers;

FIG. 15(d) shows key distribution among edge routers.

For purposes of clarity and brevity, like elements and components will bear the same designations and numbering throughout the Figures.

### DETAILED DESCRIPTION

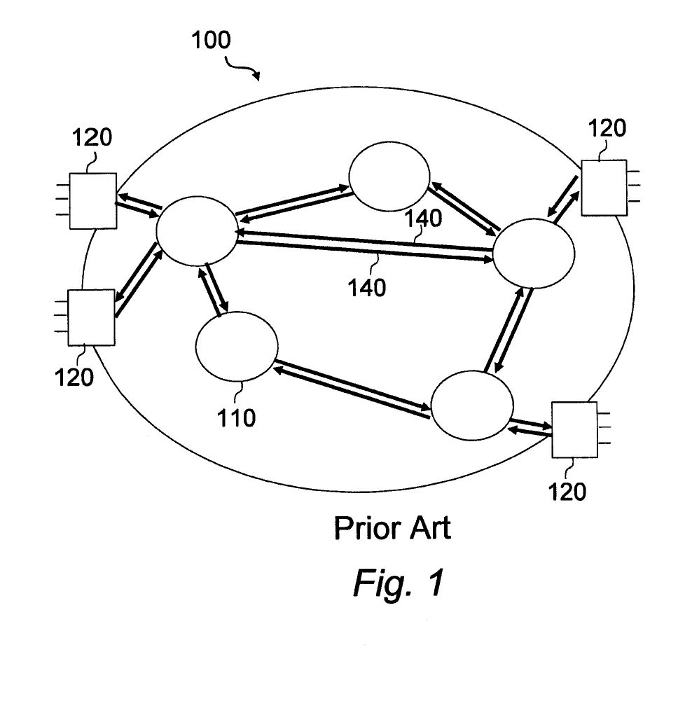

FIG. 1 shows an example of an optical burst switching network 100. The optical burst switching network 100 includes multiple electronic ingress and egress edge routers 120, and multiple optical core routers 110 connected by wavelength division multiplexing (WDM) links 140. The term WDM here includes both dense wavelength division multiplexing (DWDM) and coarse wavelength division multiplexing. The electronic ingress and egress edge routers 120 perform burst assembly and disassembly functions, and serve as legacy interfaces between the optical core routers 110 and conventional electronic routers.

As would be understood in the art, reference to a router as an ingress or egress router 120 is a relativistic term in that a single router can serve as an ingress or egress router depending on whether it is positioned at an origination point for data or a destination point for data. Similarly, a core router can be identical to an ingress or egress router in that it too can include interface lines enabling it to also serve as an origination point for data or a destination point for data. That is, any of the routers included in an optical communication link can, for a given transmission, operate as an ingress, egress or core router, depending on its location within the communication chain. Thus, the ingress, egress and/or core router can also be referred to herein as a first router, a second router and so on.

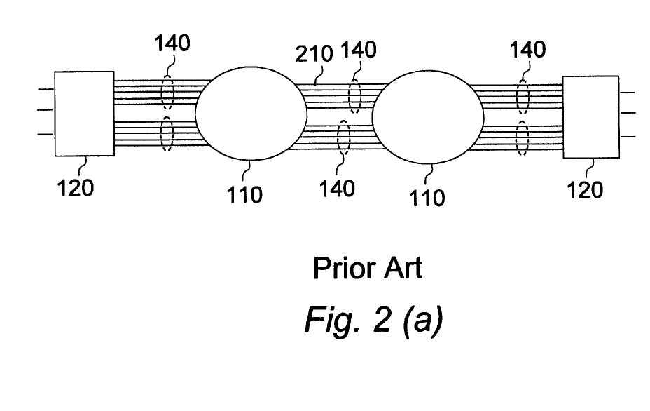

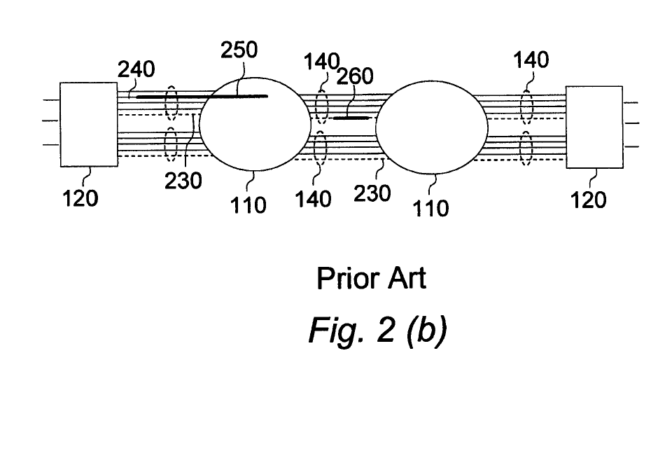

FIG. 2 (a) shows an example of routers connected by WDM links. A WDM link 140 includes multiple wavelengths 210, and represents the total unidirectional transmission capacity (in bits per second) between two adjacent routers. Two adjacent routers are typically connected with a WDM link 140 in each direction.

In optical burst switching network 100, wavelengths 210 in a WDM link 140 can be divided into a set of control channels 230, and a set of data channels 240 as illustrated in FIG. 2 (b). At least one of the wavelengths 210 in a WDM link 140 should be assigned as a control channel 230, according to one embodiment. In another embodiment, the control channel 230 can be out-of-band. In another embodiment, the control channel shares the same wavelength as the data channel. A data burst 250 is the basic data transfer block in the optical burst switching network 100. A data burst 250 can be a single data chunk, or a collection of data packets which are destined for the same destination electronic egress edge router 120. Other attributes such as quality of service (QoS) requirements may also be considered when forming data bursts 250. Data bursts 250 are of variable lengths, ranging from a single packet to an unspecified amount of data 250.

In optical burst switching network 100, before a data burst 250 is launched on one of the data wavelengths 240, a burst header 260 is launched on the control channel 230. The burst header 260 carries routing information, as well as information specific to the optical burst switching network 100. Some exemplary optical burst switching specific information are (1) offset time, specifying the time difference between the transmission of the first bit of a burst header 260 and the transmission of the first bit of its associated data burst 250; (2) burst length, or burst duration, specifying the duration of the data burst 250; (3) data wavelength identifier, specifying the data channel 240 on which the data burst 250 is transmitted; (4) QoS, specifying the quality of service to be received by the data burst 250.

An important feature of the optical burst switching network 100 is that the data burst 250 and the burst header 260 are transmitted and switched separately. The operation of the optical burst switching network 100 is described as follows. When data chunks or data packets arrive at the electronic ingress edge router 120, they are assembled into data burst 250 based on their destination electronic egress edge router addresses and other attributes such as QoS. Once the data burst 250 is formed, a burst header 260 is generated and sent on the control channel 230 at an offset time ahead of the data burst 250. The burst header 260 is processed electronically at each optical core router 110. Based on the information carried in the burst header 260, the optical core router 110 dynamically sets up an optical path shortly before the arrival of the data burst 250. According to one embodiment, the data burst 250 is not electronically processed in the optical core router 110, and is passed to the output specifying the data wavelength 240 as a pure optical signal. According to another embodiment, the data burst 250 can be converted to electronic signals in the core router 110, but is switched as an entity. In another embodiment, the data burst 250 can be temporarily stored in optical buffers such as Fiber Delay Lines (FDL). In another embodiment, the data burst 250 can be converted to electrical signals and stored in electronic RAMs. This process continues as the data burst 250 traverses the optical burst switching network 100 till it reaches the electronic egress edge router 120, where the data burst 250 is disassembled back into data chunks or data packets.

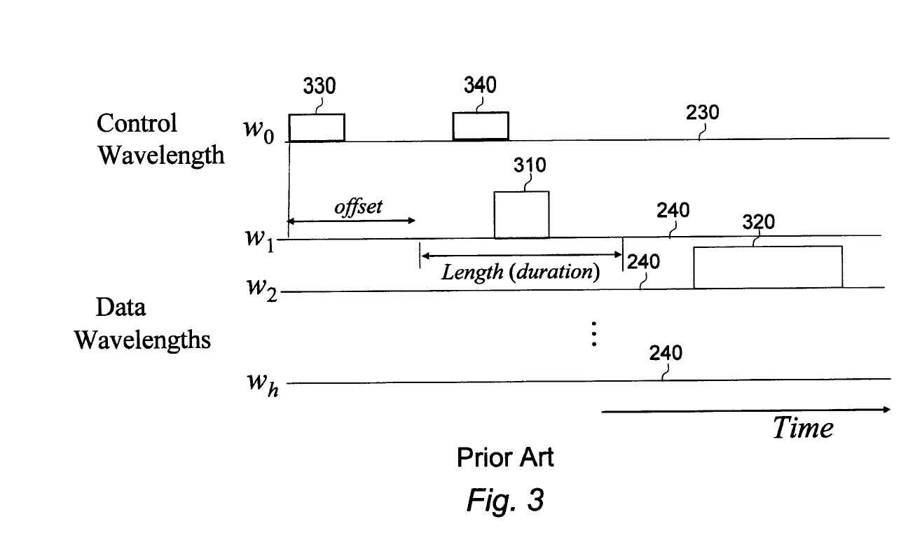

FIG. 3 shows the relationships between the burst headers 260 and their associated data bursts 250. In this example, wavelength 210 w0 is assigned as the control channel 230 to send burst headers 260, and wavelength 210 w1 to wh are assigned as data channels 240. FIG. 3 shows that data burst 1 310 and data burst 2 320 are traveling on data channel 240 w1 and w2, respectively, while burst header 1 330 and burst header 2 340 are traveling on control channel 230 w0. FIG. 3 also illustrates the offset time between burst header 1 330 and data burst 1 310, and the length (duration) of data burst 1 310.

Optical burst switching allows the burst header 260 to be processed electronically, while providing ingress-egress transparent optical paths in the optical burst switching network 100. Each burst header 260 carries necessary routing and optical burst switching network 100 specific information about the associated data burst 250 such that the data burst 250 can pass through the optical core router 110 as an optical signal.

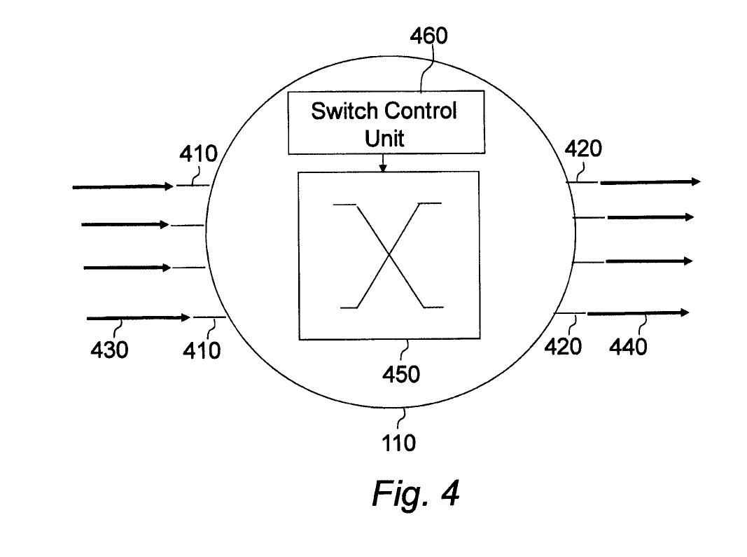

FIG. 4 shows one embodiment of an optical core router 110 connected to WDM links 140. Incoming WDM links 430 and outgoing WDM links 440 are connected to the input ports 410 and the output ports 420 of the optical core router 110. In one embodiment, the data channels 240 in the WDM links 140 are connected to an optical interconnects 450 in the OSB core router 110. In another embodiment, the data channels are converted into electrical signals, and are connected to electronic switching fabrics. The control channels 230 are connected to a switch control unit 460. The burst headers 260 sent on the control channel 230 are converted to electronic signals and processed electronically inside the switch control unit 460. Based on the information carried in the burst headers 260 and outgoing WDM link 140 status, the switch control unit 460 sets up and tears down optical paths at appropriate times to allow data bursts traveling on data wavelengths 240 to pass through the OBS core router 110.

In optical burst switching network 100, in one embodiment, data bursts 250 are launched without pre-established lightpaths. Lightpaths are set up on-the-fly as data burst 250 approaches the OBS core router 110. Contention occurs when two bursts traveling on the same wavelength compete for the same output port. When contention cannot be resolved, one of the contenting bursts has to be dropped. In another embodiment, data bursts are launched after acknowledge is received. In another embodiment, a burst header is pre-launched before data burst is assembled.

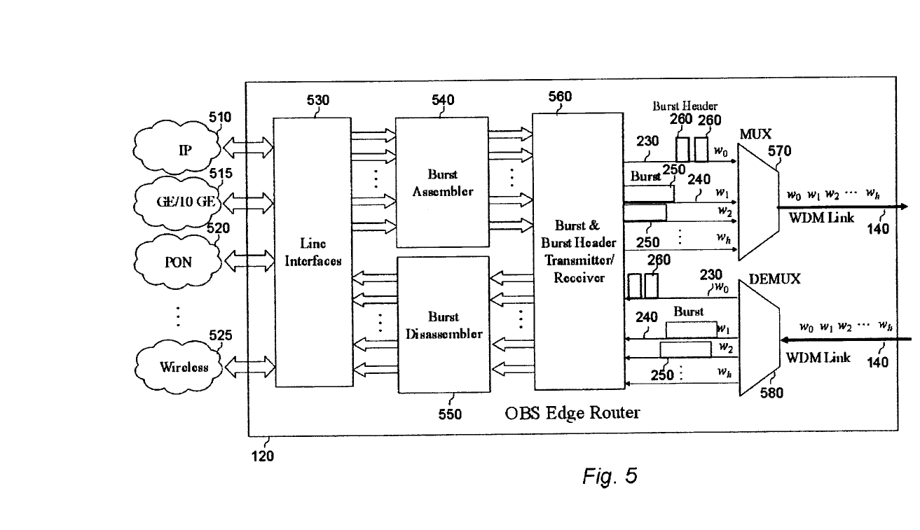

FIG. 5 illustrates the architecture of an OBS edge router 120. In the ingress direction, packets sent from different networks such as IP networks 510, Gigabit Ethernet (GE) or 10 Gigabit Ethernet (10 GE) 515, Passive Optical Network (PON) 520 and wireless networks 525 are received at the Line Interfaces 530. The types of networks that can interface with optical burst switching network are not restricted, and are specific to the Line interface design. The line interface 530 sends the received packets to the Burst Assembler 540. The Burst Assembler 540 classifies the data according to their destinations and QoS levels, and assembles data into different bursts. Once a burst 250 is formed, the burst assembler 540 generates a burst header 260, which is transmitted on the control channel 230. After holding the burst 250 for an offset time, the burst assembler 540 releases the data burst 250 to be transmitted on one of the data channels through burst and burst header transmitter/receiver 560. The control channel 230 and the data channels 240 are combined onto the outgoing WDM link 140 using a passive optical multiplexer (MUX) 570. The outgoing WDM link 140 is connected to the OBS core router 110. In the egress direction, the wavelengths on the incoming WDM link 140 are separated using an optical demultiplexer (DEMUX) 580. The burst headers 260 received on the control channel 230 and the data bursts 250 received on data channels 240 are forwarded to the Burst Disassembler 550. The burst disassembler 550 converts bursts 250 back to packets and forwards them to the appropriate line interfaces 530.

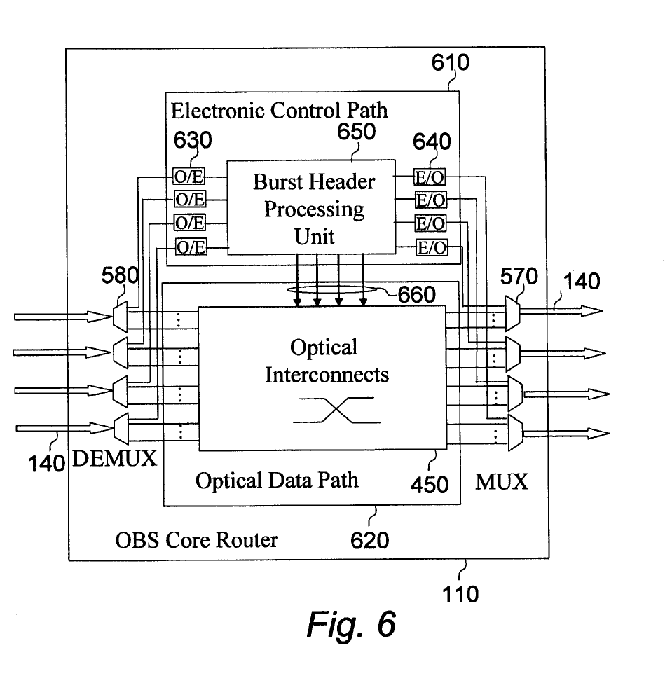

The architecture of an OBS core router 110 is illustrated in FIG. 6. The OBS core router 110 consists of an optical data path 620 and an electronic control path 610. When the WDM links 140 reaches the core router 110, wavelengths are separated by passive optical demultiplexers 580. The control channel 230 on each link 140 is tapped off and converted to electronic signals through O/E conversion 630. The burst headers 260 sent on the control channel 230 are processed electronically by the burst header processing unit 650. Depending on the architectural choices, the burst header processing unit 650 can be centralized, or distributed. In the distributed architecture, each burst header processing unit 650 will be processing burst headers 260 for one output WDM link 140, in which case, an electronic switch is used to route the burst headers 260 to the corresponding burst header processing unit 650 based on the destination address. The burst header processing unit 650 uses the information carried in the burst headers to make WDM wavelength scheduling decisions. Once an outgoing wavelength is selected for the incoming burst 250, the burst header processing unit 650 configures the optical interconnects 450 shortly before the arrival of the data burst 250 to allow the data burst 250 to pass to the desired outgoing WDM link 140 optically. The control channel 230 and the data channels 240 are combined onto the WDM link 140 at the output using passive optical multiplexers 570.

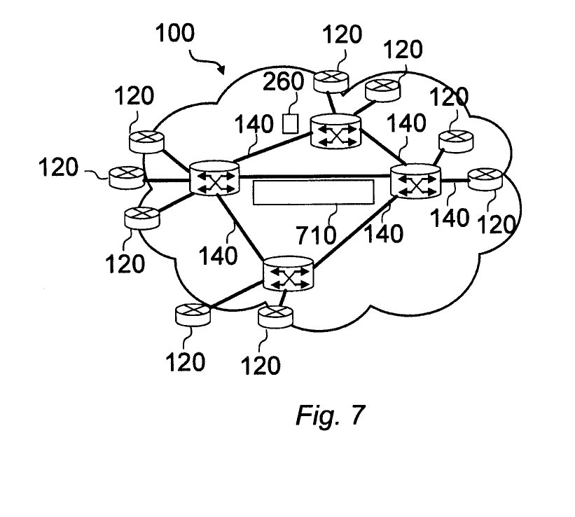

In OBS networks 100, each valid burst 250 is associated with a burst header 260, which is sent ahead of the data burst 250 on a separate control channel 230. The burst header 260 carries the control information and is responsible for making the WDM channel reservation for its corresponding burst 250. If the scheduling request is rejected at one of the OBS core routers 110, there will be no valid optical path set up for the arriving burst 250. Since the burst 250 has been launched, it is going to arrive at the input of the core router 110 in any case. At this point, the burst 250 is no longer associated with its burst header 260 and becomes an orphan burst 710 as shown in FIG. 7. Depending on the configuration of the switching fabric 450 at the time of the burst arrival, the orphan burst 710 can take some unpredictable path and reach some unpredictable destination. As a result, orphan data bursts 710 can be tapped off by some undesirable party, compromising its security.

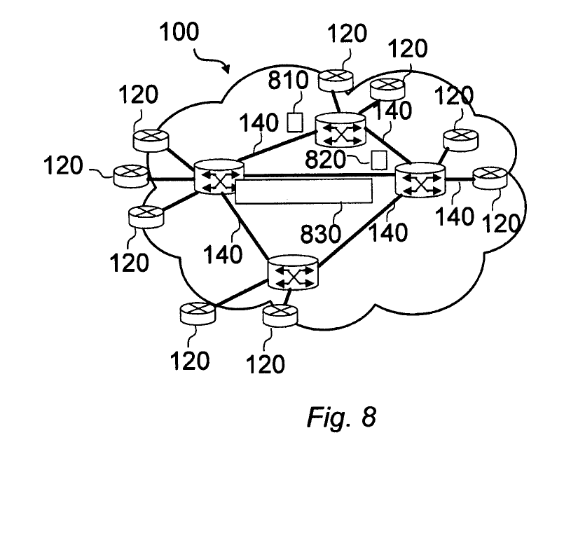

An active attack can be launched by injecting malicious burst headers 820 into the OBS network 100. In an OBS network 100, the data burst 250 bears no routing intelligence to the destination edge router 120 and will follow the optical path set up by its associated burst header 260. If a malicious burst header 820 is injected into the network by a malicious party at an appropriate time, an optical burst 830 can be misdirected to an unauthorized router, even though a path has been set up by the authentic burst header 810. Since the OBS routers 110 have no way of telling the authenticity of the burst headers 260, any active data bursts 250 that appears on the input channels can be misdirected. FIG. 8 shows security compromises caused by a malicious burst header 820 masquerading a legitimate one 810.

In this invention, in accordance with one embodiment, the optical burst switching network 100 is secured by providing the following embedded services: 1) Key distribution; 2) Authentication of burst headers 260; and 3) Confidentiality of data bursts 250. The security services will work with various routing schemes in OBS networks 100 (e.g. static routing, deflection routing, and dynamic load balancing). A major differentiating characteristic of the OBS network is its unique network architecture, and the separation of burst headers 260 and data bursts 250.

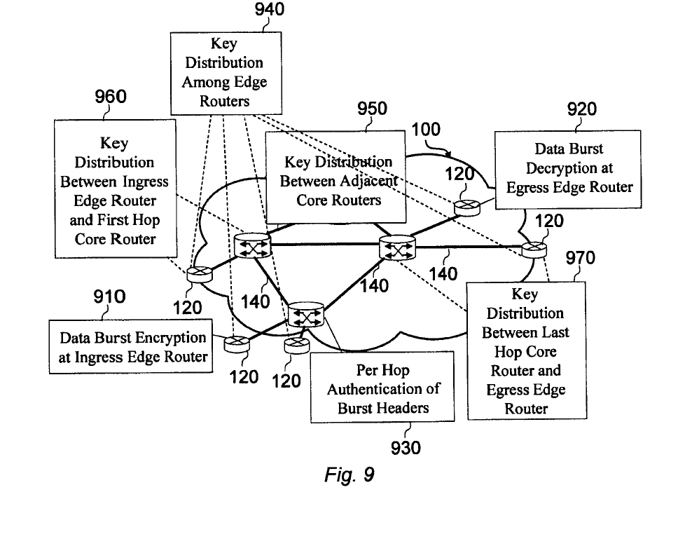

FIG. 9 illustrates one embodiment of the security architecture of the current invention: a) data burst encryption at ingress edge routers 910; b) data burst decryption at egress edge routers 920; c) per hop authentication of burst headers 930; d) key distribution among edge routers 940; e) key distribution between adjacent core routers 950; f) key distribution between the ingress edge router and the first hop core router 960; and g) key distribution between the last hop core router and the egress edge router 970. The rationale behind the architecture is explained as follows.

In OBS networks 100, data bursts 250 assembled at an ingress edge router 120 stay as an entity in the OBS core network, and are only disassembled at the destination egress edge router 120. Since data bursts 250 are transparent to OBS core routers 110, encryption/decryption of data bursts 250 is only needed between a pair of ingress and egress edge routers 120, according to one embodiment.

On the other hand, burst headers 260 are converted back to electronic form and are processed electronically at every OBS core router 110 along the path. Therefore, per hop burst header authentication is needed to ensure that no malicious burst headers 820 can alter the route of optical data bursts 250.

Because data bursts 250 are encrypted at ingress edge routers 120 and decrypted at egress edge routers 120, keys for encrypting and decrypting data bursts 250 only need to be distributed between pairs of ingress and egress routers 120 in the OBS network 100, according to one embodiment.

Since burst headers 260 need to be authenticated on a per hop basis, according to one embodiment, keys for burst header authentication need to be distributed between a) the ingress edge router 120 and the first hop core router 110, b) any connected core router 110 pairs, and c) the last hop core router 110 and the egress edge router 120.

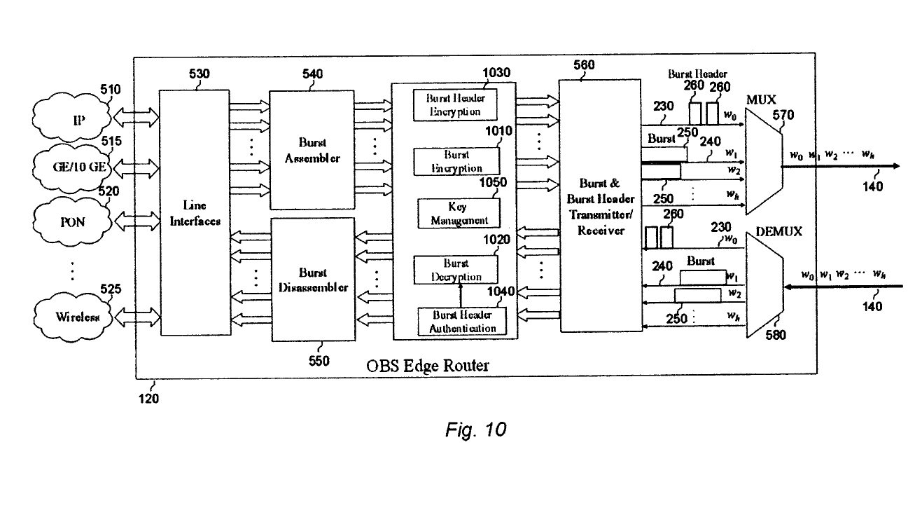

The current invention also provides a method to embed the security services in the OBS edge router 120 and the core router 110 architecture. The embedded secure OBS edge router 120 architecture according to the current invention is shown in FIG. 10. In the ingress direction, the assembled bursts 250 and their corresponding burst headers 260 are encrypted before transmission onto the optical link 140. Encryption is done on a per burst 250 basis in the burst encryption block 1030. The burst header 260 is encrypted for authentication purpose in the burst header encryption block 1030. In the egress direction, the received burst headers 260 are authenticated in the burst header authentication block 1040 before their corresponding bursts 250 are decrypted in the burst decryption block 1020 and disassembled in the burst disassembler 550. The key management block 1050 is responsible for key distribution and periodic updates.

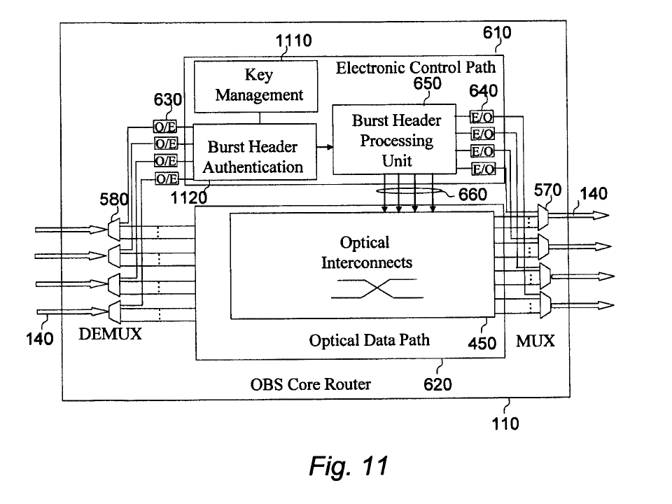

When burst headers 260 arrive at the secure OBS core router 110 shown in FIG. 11, they are authenticated in the burst header authentication block 1120 before the headers are processed for burst scheduling in the burst header processing unit 650. The key management block 1110 in the core router 110 maintains and updates proper keys for authenticating the headers.

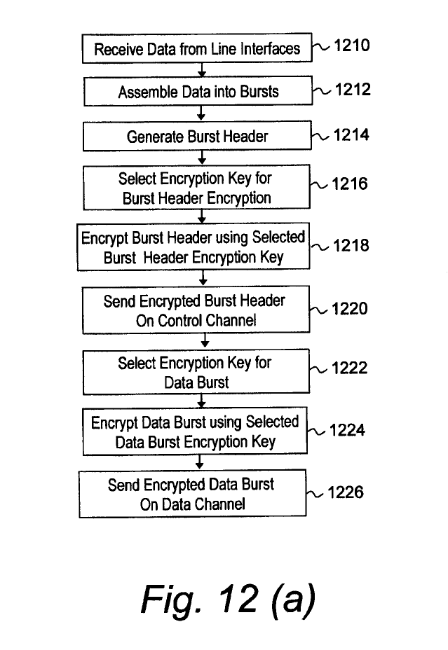

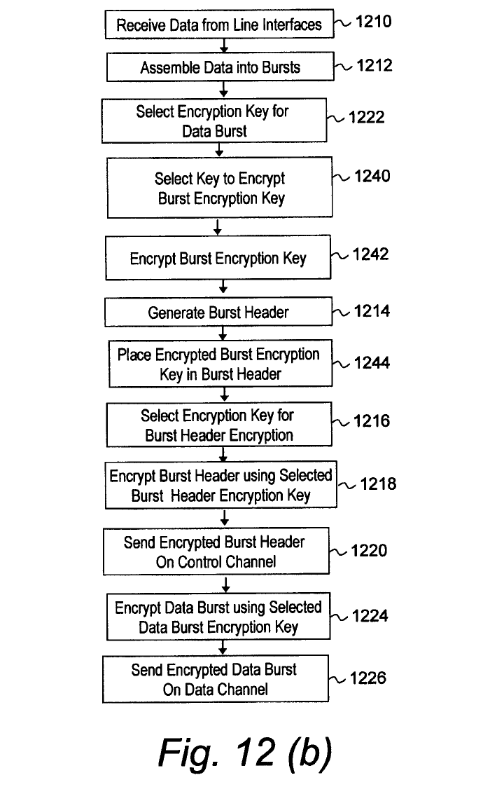

FIG. 12 (a) shows a flowchart including operations performed at the OBS edge router 120 in the ingress direction for secure transmission across OBS network 100, according to one embodiment. In a block 1210, data are received from line interfaces 530. The received data is assembled into data bursts in a block 1212. Once a burst 250 is formed in the block 1212, a burst header 260 is generated in a block 1214, which contains the addresses of the ingress and egress edge routers 120, and information about the formed burst 250, and other additional information needed.

In a block 1216, an encryption key is selected to encrypt the burst header 260. In one embodiment, the selection of the encryption key is according to the next hop core router 110 address. Once an appropriate encryption key is selected, the burst header is encrypted in a block 1218. In a block 1220, the encrypted burst header is sent on the control channel 230.

An encryption key is selected to encrypt the data burst 250 in a block 1222. In one embodiment, the selection of the encryption key is according to the destination egress edge router 120 address. In another embodiment, the selection of the key is according to the egress edge router 120 address, and the security level for the burst 250 to be encrypted. In one embodiment, one encryption key is maintained at the ingress router 120 for each egress edge router 120. In another embodiment, multiple keys are maintained at the ingress edge router 120 for the same egress edge router 120. In one embodiment, the encryption keys are maintained in RAMs. In another embodiment, the encryption keys are maintained in non-volatile memory devices. In another embodiment, the encryption keys are maintained in disk drives. Note that the encryption key to encrypt the data burst 250 is different from the encryption key used to encrypt the burst header 260. Data burst 250 is encrypted at the ingress edge router 120, and is decrypted at the destination egress edge router 120. The data burst 250 remains encrypted in the OBS network 100. On the other hand, the burst header 260 is decrypted, and then encrypted again at each OBS core router 110 for authentication purposes. The data burst 250 is encrypted in a block 1224 using the encryption key chosen in the block 1222. In a block 1226, the encrypted data burst 250 is transmitted on the data channel 240.

FIG. 12 (b) shows the flowchart of operations performed at the OBS edge router 120 in the ingress direction, according to another embodiment. In this embodiment, the encryption key for encrypting the data burst 250 is carried in its corresponding burst header 260. To do this, after a data burst 250 is formed in a block 1212, an encryption key is selected for the data burst 250 in a block 1222. The selected burst encryption key is encrypted before placing it in burst header 260. In a block 1240, an encryption key is selected based on the destination egress edge router 120 address, according to one embodiment. Note that the key to encrypt the burst encryption key is different from the key used for burst header authentication. The encrypted burst encryption key is only decrypted at the destination egress edge router 260, while burst header authentication is performed at each intermediate core router 110. In a block 1242, burst encryption key is encrypted. In a block 1214, a burst header 260 is generated. In a block 1244, the encrypted burst encryption key is placed in the payload of the burst header 260. The burst header 260 is then encrypted according to the procedures described above in blocks 1216, 1218. The encrypted burst header 260 is sent on the control channel 230 in a block 1220. In a block 1224, the data burst 250 is encrypted using the burst encryption key selected in the block 1222. The encrypted data burst 250 is sent on the data channel 240 in a block 1226.

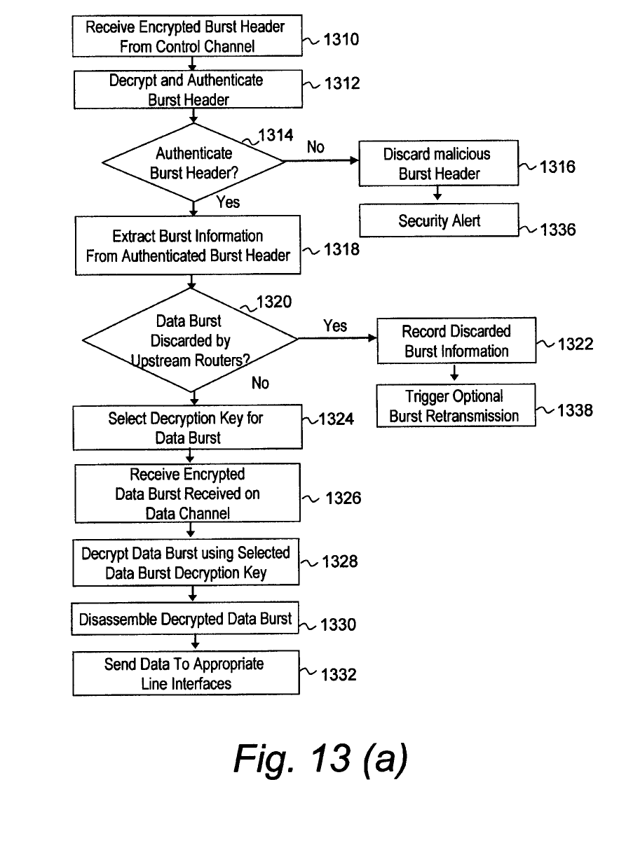

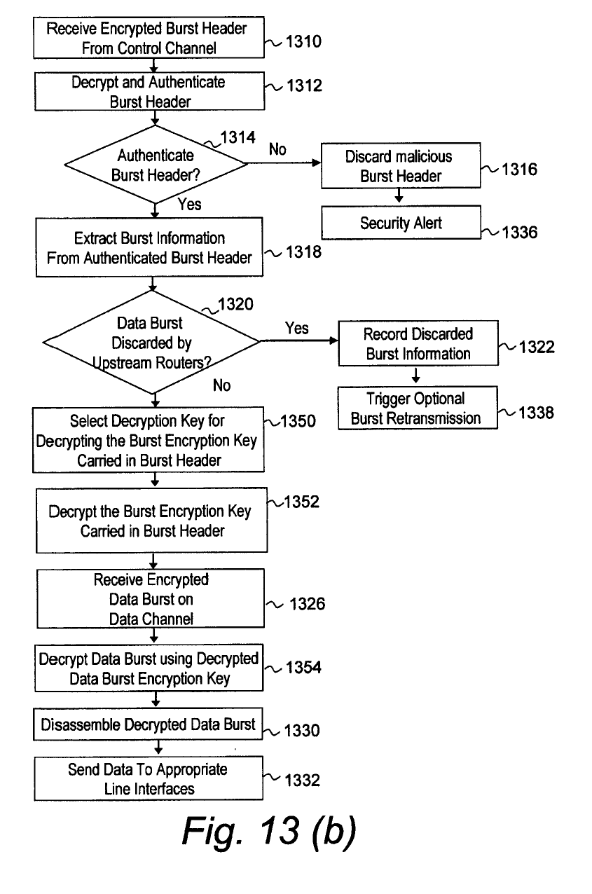

FIG. 13 (a) shows a flowchart of the operations in the OBS egress edge router, according to one embodiment. In a block 1310, the egress edge router 120 receives the encrypted burst header 260 on the control channel 230. The received burst header 260 is decrypted and authenticated in a block 1312. In a block 1314, the result from the burst header 260 authentication in the block 1312 is checked. If the burst header 260 fails the authentication, the malicious burst header 820 is discarded in a block 1316. In a block 1336, security alert is issued for possible security attack. If the burst header 260 is authentic, in a block 1318, burst information carried in the burst header 260 is extracted. In a block 1320, the extract burst information is first examined to find out if the associated data burst 250 is discarded by upstream OBS core routers 110. If the burst 250 is discarded, in a block 1322, the discarded burst information is recorded. In a block 1338, optional burst retransmission is triggered to maintain the integrity of data bursts 250. If the associated data burst 250 is not discarded by upstream OBS core routers 110, an appropriate decryption key is selected for the data burst 110 in a block 1324. In one embodiment, the key selection is according to the ingress edge router 120 address of the data burst 250. In another embodiment, the selection is according to the ingress edge router 120 address and the security level. In one embodiment, a single decryption key is maintained for each ingress edge router 120. In another embodiment, multiple decryption keys are maintained for each ingress edge router 120. In one embodiment, the decryption keys are maintained in RAMs. In another embodiment, the decryption keys are maintained in non-volatile memory devices. In another embodiment, the decryption keys are maintained in disk drives. In a block 1326, the encrypted data burst 250 is received on the data channel 240. The received data burst 250 is decrypted using the selected decryption key in a block 1328. The decrypted data burst 250 is then disassembled in a block 1330. The disassembled data is sent to appropriate line interfaces 530 in a block 1332.

FIG. 13 (b) shows a flowchart of the operations in the OBS egress edge router 120, according to another embodiment. In this embodiment, the burst encryption key is carried in the burst header 260. In a block 1350, the decryption key for decrypting the burst encryption key carried in the burst header 260 is selected according to the ingress edge router 120 address. In another embodiment, the selection is based on the in the ingress edge router 120 address and the security level. In a block 1352, the burst encryption key carried burst header 260 is decrypted. In a block 1326, the encrypted data burst 250 is received on a data channel 240. The received encrypted data burst 250 is decrypted using the decrypted data burst encryption key carried in the burst header 260, in a block 1354. The decrypted data burst 250 is disassembled in a block 1330. The disassembled data is sent to appropriate line interfaces 530 in a block 1332.

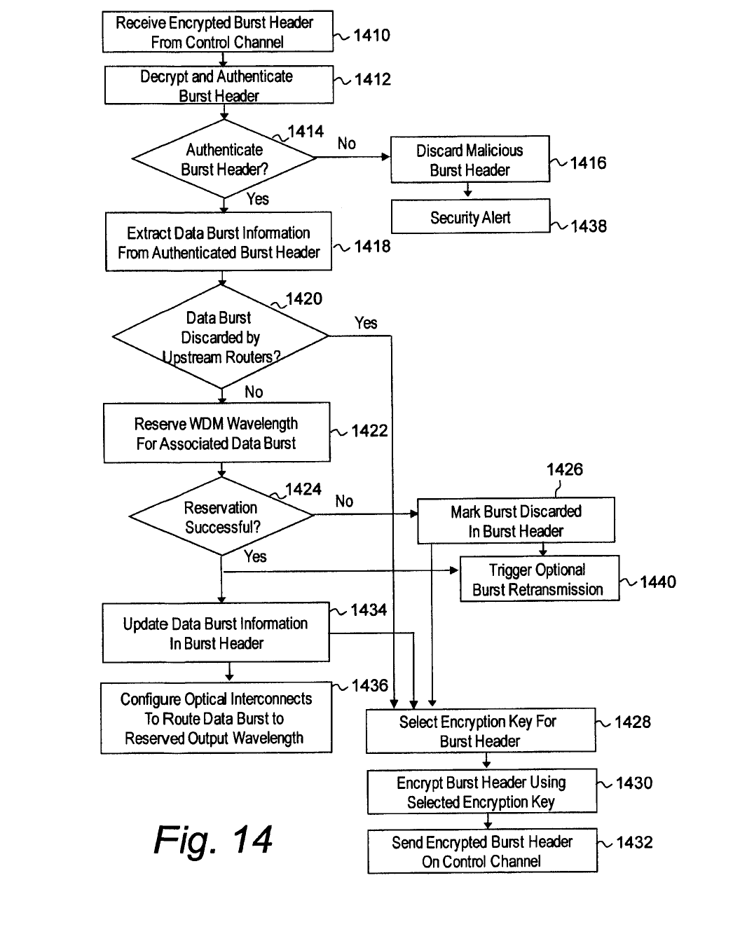

The operations in a secure OBS core router 110 according to one embodiment of the current invention are illustrated in a flowchart in FIG. 14. Encrypted burst headers 260 are received by the OBS core router 110 on the control channel 230 and are converted to electronic signals in a block 1410. The received burst headers 260 are decrypted and authenticated in a block 1412. The authentication results from the block 1412 are checked in a block 1414. If the received burst header 260 is malicious, the received burst header 260 is discarded in a block 1416. In this case, no wavelength reservation is performed, avoiding any security threats imposed by the malicious burst header. Security alter may be triggered in a block 1438 to inform high level network management software about potential security attack.

If the received burst header 260 is authentic, associated burst 250 information is extracted from the authenticated burst header 260. The status of the associated burst 250 is first checked for any discard by upstream core routers 110 in a block 1420.

If the burst 250 associated with the authenticated burst header 260 is discarded by upstream OBS core routers 110, no wavelength reservation is made. The burst header 260 in this case simply needs to be forwarded to the next hop router, which can be either a core router 110, or an egress edge router 120. To do this, in a block 1428, an appropriate encryption key is selected for the burst header 260. In one embodiment, the encryption key selection is according to the burst header's next hop router address. The burst header 260 is then encrypted using the selected encryption key in a block 1430. The encrypted burst header is then converted to optical signal and sent on the control channel 230 in a block 1432.

If the burst 250 associated with the authenticated burst header 260 is not discarded by upstream core routers 110, wavelength reservation is performed in a block 1422. Results from wavelength reservation are checked in a block 1424.

If the reservation fails, burst information in the authenticated burst header 260 is updated to indicate that the burst 250 is discarded in a block 1426. An optional burst retransmission may be triggered in a block 1440 in one embodiment. The updated burst header 260 is encrypted by the OBS core router 110 before forwarding to the next hop. This includes encryption key selection, encryption of the burst header 260, and transmission of the encrypted burst header 260 on the control channel 230 in blocks 1428, 1430 and 1432 as previously described.

If the wavelength reservation is successful, burst information is updated in the authenticated burst header in a block 1434. In one embodiment, such information includes the outgoing wavelength reserved for the burst 250, offset time between the burst header 260 and the associated burst 250. After the burst header 260 is updated, an encryption is selected in a block 1428. In one embodiment, the encryption key selection is according to the next hop router address. The burst header 260 is encrypted using the selected key in a block 1430. The encrypted burst header 260 is converted to optical signals and sent on the control channel 230 in a block 1432.

In a block 1436, the optical interconnects 450 are configured according to the wavelength reservation to route the data burst 250 to the reserved output wavelength.

In one embodiment of the current invention, burst headers 260 are authenticated at every core router 110 along the path, as well as at the egress edge router 120.

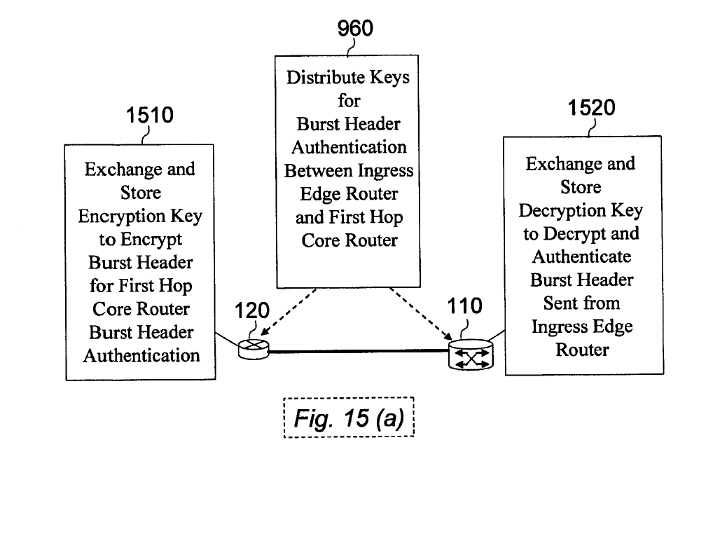

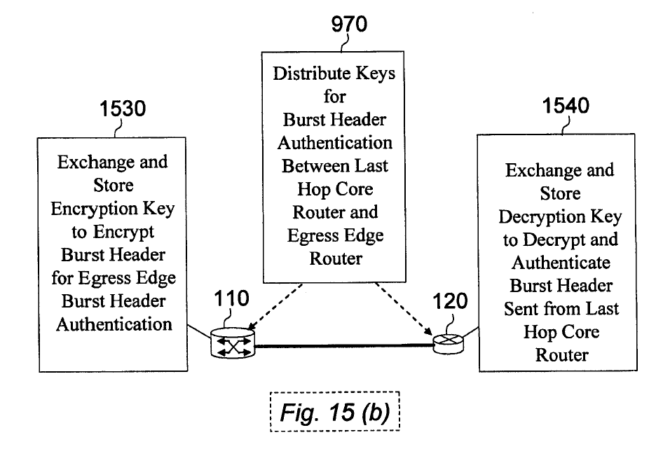

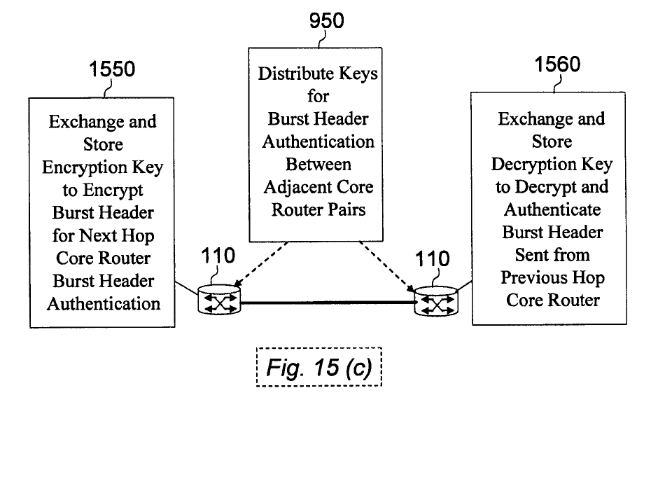

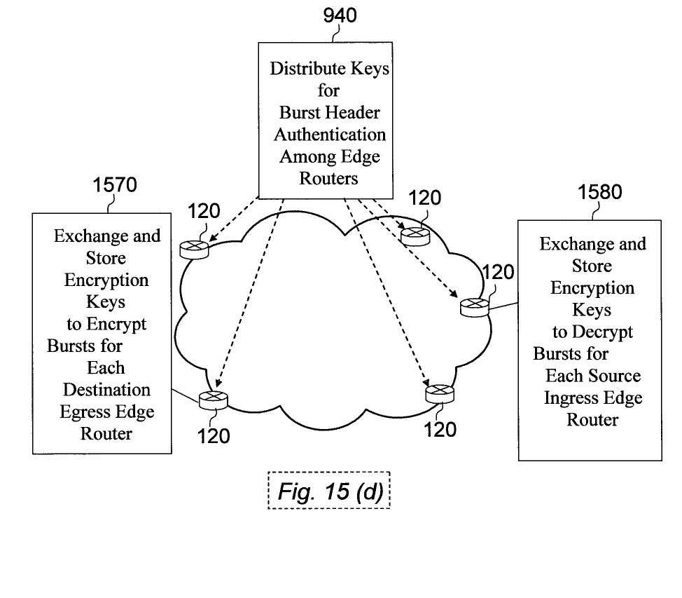

In one embodiment, encryption and decryption keys for burst header authentication are distributed between adjacent routers. FIG. 15 (a) shows the operations 960 between the ingress edge router 120 and first hop core router 110. In a block 1510, operations of exchanging and storing the encryption keys for burst headers encryption are performed at the ingress edge router 120. Operations of exchanging and storing the decryption keys for burst header authentication are performed at the first hop core router 110 in a block 1520. FIG. 15 (b) shows the encryption and decryption key exchange for burst header authentication between the last hop core router 110 and the egress edge router 120. The exchange and store of the encryption key to encrypt burst headers is performed in a block 1530 at the last hop core router 110. In a block 1540, operations to exchange and store the decryption keys used to decrypt and authenticate burst headers 260 sent from last hop core router 110 are performed at the egress edge router 120. FIG. 15 (c) shows distribution of encryption and decryption keys for burst header authentication between adjacent core routers 110. Encryption keys are exchanged and stored at the immediate upstream core router 110 in a block 1550. Decryption keys for burst header authentication are exchanged and stored in the immediate downstream core router 110 in a block 1560.

According to one embodiment of the current invention, the data burst 250 is only encrypted at the ingress edge router 120, and decrypted at the egress edge router 120. As shown in FIG. 15 (d), the encryption and decryption keys are distributed among edge routers 120. In a block 1570, operations to exchange and store encryption keys for encrypting data bursts are performed at ingress edge routers 120 for each destination egress edge router 120. In a block 1580, operations to exchange and store decryption keys for decrypting data bursts are performed at egress routers 120 for each source ingress edge router 120.

According to the current invention, any encryption mechanisms can be used.

In one embodiment, symmetric cryptography can be used. In symmetric cryptography, each pair of routers (ingress, egress, or core) will have a secret key for use by that pair. Encryption and decryption are performed using the same key. When symmetric cryptography is used, a secret key needs to be securely distributed between the pair of routers.

In another embodiment, asymmetric cryptography can be used. Asymmetric cryptography will require each router to have a distinct pair of keys—public key and private key. The public key associated with each router is distributed to every other router.

In one embodiment, AES (Advanced Encryption Standard) can be used. For encrypting data bursts, AES is the preferred embodiment due to its cryptographic strength as well as the high speed it can operate at. Other encryption methods can also be used, including but not limited to DES (Data Encryption Standard), DES3 (Triple DES), RSA, RC4, RC2-40, RC2-64, RC2-128, MD5 (Message Digest), MD4, and SHA-1 (Secure Hash). Furthermore, proprietary encryption schemes may also be employed.

There are a variety of means available for creating and distributing keys in a secure network consisting of interconnected nodes or routers in the optical burst switching network. These would include, but are not limited to, those based on the existence of a public key authority or those based on digital certificates without assuming contact with a public key authority in order to obtain a key. A key exchange based on the Diffie-Hellman algorithm is also known as a means of distributing keys as well, according to one embodiment. The Pretty Good Privacy scheme carries an encrypted key along with the payload that is encrypted by that key.

The current invention allows any known means of creating and distributing keys in a network to be used. Any key distribution scheme invented in the future can also be used in the current invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

### ELEMENT LIST

optical burst switching (OBS) network 100
optical core router 110
electronic edge router 120
Wavelength Division Multiplexing (WDM) link 140
wavelength 210
control wavelength 230
data wavelength 240
data burst 250
burst header packet 260
data burst 1 310
data burst 2 320
burst header packet 1 330
burst header packet 2 340
input ports 410
output port 420
incoming WDM link 430
outgoing WDM link 440
optical switching matrix 450
switch control unit 460
IP network 510
GE/10GE network 515
passive optical network (PON) 520
wireless network 525
line interface 530
burst assembler 540
burst disassembler 550
burst and burst header transmitter/receiver 560
optical multiplexer (MUX) 570
optical demultiplexer (DEMUX) 580
electronic control path 610
optical data path 620
O/E conversion 630
E/O conversion 640
burst header processing unit 650
optical interconnect control 660
orphan burst 710
authentic burst header 810
malicious burst header 820
redirected burst 830
data burst encryption 910
data burst decryption 920
burst header authentication 930
key distribution among edge routers 940
key distribution between adjacent core routers 950
key distribution between ingress edge router and first hop core router 960
key distribution between last hop core router and egress edge router 970
data burst encryption at edge router 1010
data burst decryption at edge router 1020
burst header encryption at edge router 1030
burst header authentication at edge router 1040
key management at edge router 1050
key management at core router 1110
burst header authentication at core router 1120
FIG. 12: Receive Data 1210
FIG. 12: Assemble Data into Bursts 1212
FIG. 12: Generate Burst Header 1214
FIG. 12: Select Encryption Key for Burst Header 1216
FIG. 12: Encrypt Burst Header 1218
FIG. 12: Send Encrypted Burst Header 1220
FIG. 12: Selected Encryption Key for Data Burst 1222
FIG. 12: Encrypt Data Burst 1224
FIG. 12: Send Encrypted Data Burst 1226
FIG. 12: Select Key to Encrypt Burst Encryption Key 1240
FIG. 12: Encrypt Burst Encryption Key 1242
FIG. 12: Place Encrypted Burst Encryption Key in Burst Header 1244
FIG. 13: Receive Encrypted Header 1310
FIG. 13: Decrypt and Authenticate Header 1312
FIG. 13: Is Authenticate Header 1314
FIG. 13: Discard Burst Header 1316
FIG. 13: Extract Burst Info 1318
FIG. 13: Is Data Burst Discarded 1320
FIG. 13: Record Discarded Burst Info 1322
FIG. 13: Select Decryption Key for Data Burst 1324
FIG. 13: Receive Encrypted Data Burst 1326
FIG. 13: Decrypt Data Burst 1328
FIG. 13: Disassemble Decrypted Data Burst 1330
FIG. 13: Send Data to Line Interfaces 1332
FIG. 13: Security Alert 1336
FIG. 13: Select Decryption Key for Encrypted Burst Encryption Key 1350
FIG. 13: Decrypt Burst Encryption Key 1352
FIG. 13: Decrypt Data Burst Using Decrypted Burst Encryption Key 1354
FIG. 13: Trigger Optional Burst Retransmission 1338
FIG. 14: Receive Encrypted Burst Header 1410
FIG. 14: Decrypt and Authenticate Burst Header 1412
FIG. 14: Is Authenticate Burst Header 1414
FIG. 14: Discard Malicious Burst Header 1416
FIG. 14: Extract Burst Info 1418
FIG. 14: Is Burst Discarded 1420
FIG. 14: Reserve WDM Wavelength 1422
FIG. 14: Is Reservation Successful 1424
FIG. 14: Mark Burst Discard in Header 1426
FIG. 14: Select Encryption Key for Burst Header 1428
FIG. 14: Encrypt Burst Header 1430
FIG. 14: Send Encrypted Burst Header 1432
FIG. 14: Updated Burst Info in Burst Header 1434
FIG. 14: Configure Optical Interconnect 1436
FIG. 14: Security Alert 1438
FIG. 14: Trigger Optional Burst Retransmission 1440
FIG. 15 (a): Exchange and store encryption key at ingress edge router 1510
FIG. 15 (a): Exchange and store decryption key at first hop core router 1520
FIG. 15 (b): Exchange and store encryption key at last hop core router 1530
FIG. 15 (b): Exchange and store decryption key at egress router 1540
FIG. 15 (c): Exchange and store encryption key at upstream core router 1550
FIG. 15 (c): Exchange and store decryption key at next hop core router 1560
FIG. 15 (d): Exchange and store encryption key at ingress edge router 1570
FIG. 15 (d): Exchange and store decryption key at egress edge router 1580

What is claimed is:

1. An optical network, comprising:
at least one optical communication link;
a first router having line interfaces receiving data and classifying said data based on destination, forming a data burst based on destination, selecting an encryption key for header encryption, encrypting a header for said data burst using said selected header encryption key, sending said encrypted header on said at least one optical communication link, and sending said data burst on said at least one optical communication link; and
a second router at least one hop away from said first router and receiving said encrypted header from said at least one communication link, decrypting and authenticating said header, extracting data burst information from said header, said second router having an address and determining whether the address of the second router is the destination address for said data burst,
wherein when the address of said second router is the destination address for the data burst, said second router:
receiving said data burst via said optical communication link, and
sending data from the data burst to the appropriate line interfaces; and
wherein when the address of the second router is not the destination address for the data burst, said second router:
selecting and reserving a wavelength of a second optical communication link for said data burst associated with said header,
selecting an encryption key for the header,
encrypting said header using the selected header encryption key,
sending said encrypted header via said second optical communication link, and
routing said data burst to the selected wavelength of said second optical communication link.

2. The optical network of claim 1, wherein said first router and said second router distribute an encryption/decryption key for encrypting/decrypting said header.

3. The optical network of claim 2, wherein said first router and said second router utilize a dedicated wavelength to distribute said encryption/decryption key.

4. The optical network of claim 1, wherein said data burst includes one or more data packets which are destined for the same destination.

5. The optical network of claim 1, wherein when the address of said second router is the destination address for said data burst, said second router disassembles said data burst before sending data to said appropriate line interface.

6. The optical network of claim 1, wherein when the address of said second router is not the destination address of said data burst, said second router marks, in said header, said data burst as discarded if said second router is unable to reserve said wavelength in said second optical communication link.

7. The optical network of claim 1, further comprising:
selecting, by said first router, an encryption key for said data burst and encrypting said data burst using said selected encryption key; and
when the address of said second router is the destination address for said data burst,
selecting a decryption key for said data burst via the second router and decrypting said data burst with said selected decryption key before sending data to said appropriate line interface.

8. An optical network, comprising:
at least one optical communication link;
a first router having line interfaces receiving data and classifying said data based on destination, forming a data burst based on destination, sending a header for said data burst on said at least one optical communication link, selecting an encryption key for said data burst, encrypting said data burst using said selected data burst encryption key, and sending said encrypted data burst on said at least one optical communication link; and
a second router at least one hop away from said first router and receiving said header from said communication link, extracting data burst information from said header, said second router having an address and determining whether the address of said second router is said destination address for said data burst,
wherein when said address of said second router is said destination address for said data burst, said second router:
selecting a decryption key for said data burst,
receiving said encrypted data burst via said at least one optical communication link,
decrypting said encrypted data burst with said selected decryption key, and
sending data from said data burst to appropriate line interfaces; and
wherein when said address of said second router is not said destination address for said data burst, said second router:
selecting and reserving a wavelength for said data burst associated with said header in a second optical communication link of said at least one optical communication link.
sending said header via said second optical communication link, and
routing said data burst to said selected wavelength of said second optical communication link of said at least one optical communication link.

9. The optical network of claim 8, wherein said first router and said second router distribute an encryption/decryption key for encrypting/decrypting said data burst.

10. The optical network of claim 9, wherein said first router and said second router utilize a dedicated wavelength to distribute said encryption/decryption key.

11. The optical network of claim 8, wherein said data burst includes one or more data packets which are destined for the same destination.

12. The optical network of claim 8, wherein when said address of said second router is said destination address for said data burst, said second router disassembles said data burst before sending data to said appropriate line interface.

13. The optical network of claim 8, wherein when the address of said second router is not said destination address of said data burst, said second router marks, in said header, said data burst as discarded if said second router is unable to reserve a wavelength in said second optical communication link.

14. The optical network of claim 8, further comprising:
selecting, by said first router, an encryption key for said header and encrypting said header using said selected encryption key; and
when the address of said second router is not the destination address for said data burst,
selecting an encryption key for said header via the second router and encrypting said header with said selected encryption key before sending said encrypted header via said second optical communication link.

15. A method for secure transmission of data in an optical WDM network comprising the steps of:
receiving and classifying, by a first router, data from at least one line interface, based on destination;
forming, by said first router, a data burst based on destination;
selecting an encryption key for header encryption;
encrypting a header for said data burst using the selected header encryption key;
sending the encrypted header and said data burst, via a first optical communication link;
receiving, by a second router at least one hop away from said first router and having an address, said encrypted header and said data burst;
decrypting and authenticating said header;
extracting data burst information from said header;
determining, by said second router, whether said destination address for said data burst is the same as said address for said second router;
wherein when said address of said second router is the destination address for said data burst, said second router:
receiving said data burst via said optical communication link and sending data to an appropriate line interface;
wherein when said address of said second router is not said destination address for said data burst, said second router:
selecting a wavelength of a second optical communication link for said data burst associated with said header,
selecting an encryption key for said header,
encrypting said header using the selected header encryption key,
sending the encrypted header via said second optical communication link, and
routing said data burst to said selected wavelength.

16. The method of claim 15, further comprising the step of:
distributing, via said first router and said second router, an encryption/decryption key for encrypting/decrypting said header.

17. The method of claim 16, wherein said first router and said second router utilize a dedicated wavelength to distribute said encryption/decryption key.

18. The method of claim 15, wherein said data burst includes one or more data packets which are destined for the same destination.

19. The method of claim 15, wherein when the address of said second router is the destination address for said data burst, further comprising the step of:
disassembling, by said second router, said data burst before sending data to said appropriate line interface.

20. The method of claim 15, wherein when the address of said second router is not the destination address of said data burst, further comprising the step of:
marking, by said second router, in said header, said data burst as discarded if said second router is unable to reserve said wavelength in said second optical communication link.

21. The method of claim 15, further comprising the step of:
selecting, by said first router, an encryption key for said data burst and encrypting said data burst using said selected encryption key; and
when the address of said second router is the destination address for said data burst,
selecting a decryption key for said data burst via the second router and decrypting said data burst with said selected decryption key before sending data to said appropriate line interface.

22. A method for secure transmission of data in an optical WDM network comprising the steps of:
receiving and classifying, by a first router, data from at least one line interface, based on destination;
forming, by said first router, a data burst based on destination;
sending a header for said data burst via a first optical communication link;
selecting an encryption key for data burst encryption;
encrypting said data burst using said selected encryption key;
sending said encrypted data burst, via said first optical communication link;
receiving said header; by a second router at least one hop away from said first router and having an address, said header;
extracting data burst information from said header;
determining, by said second router, whether said destination address for said data burst is the same as the address for said second router;
wherein when the address of said second router is the destination address for said data burst, said second router:
selecting a decryption key for data burst,
receiving said encrypted data burst via said second optical communication link,
decrypting said encrypted data burst with said selected decryption key, and
sending data to an appropriate line interface;
wherein when the address of said second router is not the destination address for said data burst, said second router:
selecting a wavelength of a second optical communication link for said data burst associated with said header,
sending said header via said second optical communication link, and
routing said data burst to said selected wavelength.

23. The method of claim 22, further comprising the step of:
distributing, by said first router and said second router, an encryption/decryption key for encrypting/decrypting said data burst.

24. The method of claim 23, wherein said first router and said second router utilize a dedicated wavelength to distribute said encryption/decryption key.

25. The method of claim 22, wherein said data burst includes one or more data packets which are destined for the same destination.

26. The method of claim 22, wherein when said address of said second router is said destination address for said data burst, further comprising the step of:
disassembling, by said second router, said data burst before sending data to said appropriate line interface.

27. The method of claim 22, wherein when the address of said second router is not said destination address of said data burst, further comprising the step of:
marking, by said second router, in said header, said data burst as discarded if said second router is unable to reserve a wavelength in said second optical communication link.

28. The method of claim 22, further comprising:
selecting, by said first router, an encryption key for said header and encrypting said header using said selected encryption key; and
when the address of said second router is not the destination address for said data burst,
selecting an encryption key for said header via the second router and encrypting said header with said selected encryption key before sending said encrypted header via said second optical communication link.
